(19) United States
(12) Patent Application Publication
(10) Pub. No.: US 2025/0264493 A1
(43) Pub. Date: Aug. 21, 2025

(54) SENSOR FOR DETECTING A ROTATIONAL SPEED AND/OR DIRECTION OF ROTATION OF A WHEEL OF A VEHICLE, SYSTEM COMPRISING SUCH A SENSOR, AND VEHICLE COMPRISING SUCH A SYSTEM

(71) Applicant: KNORR-BREMSE Systeme für Nutzfahrzeuge GmbH, München (DE)

(72) Inventors: Christian Huber, München (DE); Patrick Bollig, Mühlacker (DE); Amadeus Mlynarski, München (DE); Andreas Sesselmann, Miesbach (DE); Felix Thierfelder, Unterschleissheim (DE)

(21) Appl. No.: 19/057,300

(22) Filed: Feb. 19, 2025

(30) Foreign Application Priority Data
Feb. 20, 2024 (DE) 102024104617.1

(51) Int. Cl. G01P 3/487; G01B 7/30; G01D 5/14; G01D 5/16

(52) U.S. Cl. CPC G01P 3/487; G01B 7/30; G01D 5/145; G01D 5/16

(57) ABSTRACT

A sensor for detecting a rotational speed and/or direction of rotation of a wheel of a vehicle. The sensor includes a first magnetic field sensor chip and a second magnetic field sensor chip, wherein the first and second magnetic field sensor chips are each independently configured to output a sensor signal indicative of a change in a biased magnetic field under the influence of a rotating pole wheel coupled to the wheel of the vehicle. The sensor includes a first receptacle through which the first magnetic field sensor chip is received and a second receptacle through which the second magnetic field sensor chip is received. The sensor also includes at least one permanent magnet for generating the biased magnetic field, wherein the at least one permanent magnet (18) is disposed in the receiving body at one or both of the first and second receptacles.

The present invention relates to a sensor for detecting a rotational speed and/or direction of rotation of a wheel of a vehicle, a system comprising such a sensor, and a vehicle comprising such a system.

In the prior art, particularly in the field of commercial vehicles, there are sensors for detecting the rotational speed and/or direction of rotation of a wheel with a magnetic field sensor chip, which conventionally has integrated circuits encapsulated in an encapsulation material made of a polymer, for example, for measuring and evaluating magnetic fields and their changes. Furthermore, these sensors have a permanent magnet as a so-called back-bias magnet for generating a magnetic field, changes to which can be detected by the magnetic field sensor chip when no other magnetic field, for example generated by a magnetic object such as a multi-pole wheel of a passenger car, is present. The permanent magnet is used here to magnetically bias the magnetic field sensor chip so that it can detect a magnetic field change caused by a non-magnetic object such as a pole wheel of a commercial vehicle which is coupled to a wheel of the commercial vehicle and which can influence the magnetic field lines of the magnetic field biased by the permanent magnet.

Especially in the field of autonomous commercial vehicles, it is desirable to have durable and fail-safe sensors that also save space.

It is therefore the object of the present invention to provide an improved sensor for detecting a rotational speed and/or direction of rotation of a wheel of a vehicle, a system comprising such a sensor, and a vehicle comprising such a system.

This problem is solved by the independent claims. Exemplary embodiments are presented in the dependent claims.

According to the invention, a sensor for detecting a rotational speed and/or direction of rotation of a wheel of a vehicle is provided, wherein the sensor comprises a first magnetic field sensor chip and a second magnetic field sensor chip, wherein the first and second magnetic field sensor chips are each independently configured to output a sensor signal indicative of a change in a biased magnetic field under the influence of a rotating pole wheel coupled to the wheel of the vehicle; a receiving body having a first receptacle through which the first magnetic field sensor chip is received and a second receptacle through which the second magnetic field sensor chip is received; and at least one permanent magnet for generating the biased magnetic field, wherein the at least one permanent magnet is disposed in the receiving body at at least one of the first and second receptacles.

Advantageously, a sensor according to the invention can be used to achieve redundant detection of a rotational speed and/or direction of rotation of a wheel of a vehicle in a particularly space-saving manner. The two magnetic field sensor chips, the first and the second magnetic field sensor chip, can operate independently of each other so that one of the two magnetic field sensor chips can fail and the rotational speed and/or direction of rotation can still be detected using the other magnetic field sensor chip. This increases the fail-safety and reliability of a sensor for detecting the rotational speed and/or direction of rotation of a wheel.

By arranging the first and second magnetic field sensor chips in one of the two receptacles, the first and second receptacles respectively, and the at least one permanent magnet, which is generally a relatively large component, on at least one of the two receptacles, it is possible to provide a compact and space-saving sensor for detecting a rotational speed and/or direction of rotation of a wheel.

According to one embodiment, the sensor signal is an analog or digital electrical signal.

According to one embodiment, the receiving body has a longitudinal extent and a transverse extent transverse to the longitudinal extent, which is shorter than the longitudinal extent and in particular is substantially perpendicular to the longitudinal extent.

According to one embodiment, the receiving body has a cuboid or cylindrical shape.

According to one embodiment, the first and second receptacles are arranged next to each other transversely to a longitudinal axis of the receiving body. In particular, the first receptacle and the second receptacle can be arranged next to each other substantially parallel to a running direction or direction of rotation of a pole wheel. The first and second receptacles can be arranged next to each other substantially parallel to the vector of the running direction or direction of rotation, which is tangential to the pole wheel. The first and second receptacles can be arranged next to each other substantially in a direction tangential to the pole wheel.

This embodiment makes it possible to provide a particularly compact and space-saving sensor that is able to detect the rotational speed and/or direction of rotation of a wheel redundantly.

According to one embodiment, the first and second receptacles are arranged one behind the other along a longitudinal axis of the receiving body. In particular, the first and second receptacles can be arranged one behind the other substantially perpendicular to a running direction or direction of rotation of a pole wheel. The first and second receptacles can be arranged one behind the other substantially perpendicular to the vector of the running direction or direction of rotation, which is tangential to the pole wheel. The first and second receptacles can be arranged one behind the other substantially in the radial direction to the pole wheel.

This embodiment also makes it possible to provide a particularly compact and space-saving sensor that is able to detect the rotational speed and/or direction of rotation of a wheel redundantly.

According to one embodiment, the first receptacle is arranged along a longitudinal axis of the receiving body at or near a longitudinal end of the receiving body. Furthermore, the second receptacle is arranged along the longitudinal axis of the receiving body at or near the longitudinal end of the receiving body.

According to one embodiment, the first receptacle and the second receptacle are arranged at an end of the receiving body facing a pole wheel.

According to one embodiment, the at least one permanent magnet is arranged behind the first and second magnetic field sensor chip in the direction of longitudinal extent of the receiving body from a longitudinal end of the receiving body.

According to one embodiment, the at least one permanent magnet is arranged behind the first magnetic field sensor chip and the second magnetic field sensor chip in the direction of an end of the receiving body facing a pole wheel.

According to one embodiment, the at least one permanent magnet is attached to at least one of the first and second magnetic field sensor chips. The at least one permanent magnet may, for example, be bonded to an outer surface, in particular of the encapsulation material, of the first, the second or the first and second magnetic field sensor chips. In particular, the at least one permanent magnet can be integrated into at least one of the first and second magnetic field sensor chips. The at least one permanent magnet can, for example, be integrated in the first, second or in the first and second magnetic field sensor chip. The at least one permanent magnet can be encapsulated by or embedded in the encapsulation material of the first, second or first and second magnetic field sensor chip.

According to one embodiment, the at least one permanent magnet is larger than the first magnetic field sensor chip and/or the second magnetic field sensor chip.

Each of the at least one permanent magnet can generate a magnetic field. The generated magnetic fields can add up or overlap to form an overall magnetic field. The first and second magnetic field sensor chips can each perceive and/or detect changes in the total magnetic field.

According to one embodiment, the receiving body comprises a third receptacle through which the at least one permanent magnet is received.

The third receptacle makes it possible to securely accommodate the at least one permanent magnet in the receiving body. Furthermore, the permanent magnet can be exchanged and permanent magnets with different magnetic field strengths can be used easily.

According to one embodiment, the third receptacle is arranged behind the first and second receptacles in the direction of longitudinal extent of the receiving body from a longitudinal end of the receiving body. The third receptacle can be arranged behind the first and second receptacles in the direction of an end of the receiving body facing a pole wheel.

According to one embodiment, the first receptacle has two sensor chip contact receptacles for receiving contact legs of the first magnetic field sensor chip when it is arranged in the first receptacle. In a further embodiment, the second receptacle has two sensor chip contact receptacles in order to receive contact legs of the second magnetic field sensor chip when the latter is arranged in the second receptacle.

According to one embodiment, the at least one permanent magnet comprises a first permanent magnet and a second permanent magnet, wherein the first permanent magnet is arranged on the first receptacle and the second permanent magnet is arranged on the second receptacle.

The first permanent magnet generates a first magnetic field. The second permanent magnet generates a second magnetic field. The first and second magnetic fields can add up or overlap to form a biased total magnetic field.

According to one embodiment, the first permanent magnet is attached to the first magnetic field sensor chip. The first permanent magnet can, for example, be bonded to an outer surface, in particular of the encapsulation material, of the first magnetic field sensor chip. In particular, the first permanent magnet can be integrated into the first magnetic field sensor chip. The first permanent magnet can be encapsulated by or embedded in the encapsulation material of the first magnetic field sensor chip. Furthermore, the second permanent magnet is attached to the second magnetic field sensor chip. The second permanent magnet can, for example, be bonded to an outer surface, in particular the encapsulation material, of the second magnetic field sensor chip. In particular, the second permanent magnet can be integrated into the second magnetic field sensor chip. The second permanent magnet can be encapsulated by the encapsulation material of the second magnetic field sensor chip or embedded in it.

According to one embodiment, the receiving body comprises a third and a fourth receptacle, wherein the first permanent magnet is received by the third receptacle and the second permanent magnet is received by the fourth receptacle.

The third and fourth receptacles allow the first and second permanent magnets to be securely accommodated in the receptacle. Furthermore, the first and second permanent magnets can be easily exchanged and replaced by permanent magnets with different magnetic field strengths.

According to one embodiment, the third receptacle is arranged behind the first receptacle in the direction of longitudinal extent of the receiving body from a longitudinal end of the receiving body. In particular, the third receptacle can be arranged behind the first receptacle in the direction of an end of the receiving body that faces a pole wheel. Furthermore, the fourth receptacle is arranged behind the second receptacle in the direction of longitudinal extent of the receiving body from a longitudinal end of the receiving body. In particular, the fourth receptacle can be arranged behind the second receptacle in the direction of the end of the receiving body facing the pole wheel.

According to one embodiment, the first permanent magnet is larger than the first and/or second magnetic field sensor chip. The second permanent magnet is larger than the second and/or first magnetic field sensor chip.

According to one embodiment, the first magnetic field sensor chip is a Hall effect sensor chip or a magnetoresistive sensor chip. Furthermore, the second magnetic field sensor chip is a Hall effect sensor chip or a magnetoresistive sensor chip.

According to one embodiment, the first magnetic field sensor chip is a directional sensor chip and the second magnetic field sensor chip is a directional sensor chip.

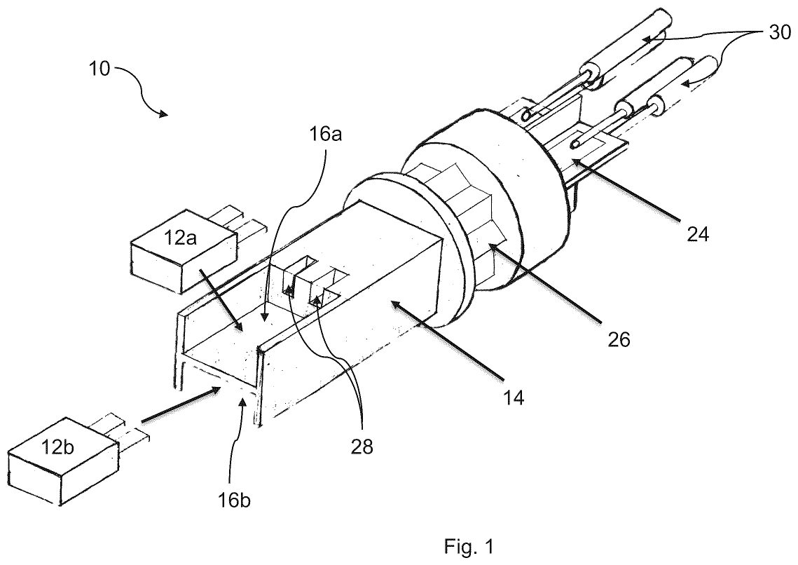

“Directional” sensor chips are understood to be sensor chips that are to be mounted in a predetermined orientation in a vehicle so that the measuring elements of the sensor chips are aligned with a movement of pole wheels, wherein the orientation must not change, even during operation. Embodiments of such directional sensor chips and their aligned arrangement are described, for example, in the publication DE 10 2019 125 405 A1, the relevant content of which is incorporated into the description by reference. In particular, reference is made to FIGS. 1 to 7 and their description in DE 10 2019 125 405 A1.

According to a further embodiment, the first magnetic field sensor chip is an omnidirectional sensor chip and the second magnetic field sensor chip is an omnidirectional sensor chip.

“Omnidirectional” sensor chips are sensor chips of which the constant alignment relative to a pole wheel over time is not of functional significance. This means that they can be mounted independently of the movement of a pole wheel. In particular, omnidirectional sensor chips can be provided independently of a rotating pole wheel. An omnidirectional sensor chip can also determine magnetic field changes induced by the pole wheel during relative movements between the pole wheel and the sensor. More precisely, an omnidirectional sensor chip also functions with a constant rotated alignment of the sensor around the sensor axis to a pole wheel over time. Despite relative movements between the sensor and the pole wheel, the sensor can function properly and determine magnetic field changes consistently and without significant deviations.

According to one embodiment, an omnidirectional sensor chip is a chip with at least a first, a second and a third magnetic field measuring element, which are each adapted to provide a first, second and third magnetic field signal, the amplitudes of which are proportional to a magnetic field emanating from a rotating object, such as a pole wheel, or emanating from a permanent magnet and deflected by the movement of the rotating object. The normal vectors of the at least three magnetic field measuring elements are linearly independent of each other. This means, for example, that they can each enclose an angle of 90° with each other, such as a Cartesian coordinate system. A signal acquisition unit is adapted to a first difference signal and a second difference signal, wherein the first difference signal is based on a difference between the magnetic field signal of the first magnetic field measuring element and the second magnetic field measuring element, and the second difference signal is based on a difference between the magnetic field signals of the first magnetic field measuring element and the third magnetic field measuring element. The signal acquisition unit is further adapted to calculate and output a combined signal based on the magnetic field signal of the first magnetic field measuring element and the first difference signal and the second difference signal. An evaluation unit is then adapted to generate an output signal which includes a speed of movement and a direction of movement of the rotating object. Such an omnidirectional sensor chip is described, for example, in publication WO 2022/008265 A1, the relevant content of which is incorporated into this description by reference. In particular, reference is made to FIGS. 1 to 3 and their description in WO 2022/008265 A1.

According to one embodiment, the first magnetic field sensor chip is a directional sensor chip and the second magnetic field sensor chip is an omnidirectional sensor chip. Alternatively, the first magnetic field sensor chip is an omnidirectional sensor chip and the second magnetic field sensor chip is a directional sensor chip.

According to one embodiment, the first and second magnetic field sensor chips are of different chip types. For example, the first and second magnetic field sensor chips can each be from different manufacturers.

By using different magnetic field sensor chips, for example from different manufacturers, in one sensor, common mode errors can be reduced or even minimized.

According to one embodiment, the receptacles, in particular the first and second receptacles, are designed as chambers in the receiving body. The third and fourth receptacles can also be designed as chambers. The receptacles can also be designed as pockets or inserts in the receiving body or as clips.

According to one embodiment, the sensor comprises a sensor housing. The sensor housing may further comprise a shape feature for alignment of the sensor, said feature being shaped to provide a predetermined alignment of the sensor relative to a pole wheel.

According to one embodiment, the sensor housing has a cuboid or cylindrical shape. Furthermore, the sensor housing can be a sleeve.

According to one embodiment, the shape feature is arranged on an outer surface of the sensor housing. The shape feature can be an elevation of the sensor housing extending in the direction of longitudinal extent of the receiving body. In particular, the shape feature can be an alignment lug or alignment rib. A shape feature is also described in publication DE 10 2019 125 405 A1, the content of which is incorporated into this description by reference.

According to one embodiment, the receiving body comprises three electrical contacts for making electrical contact with the first and second magnetic field sensor chips.

By combining the mass, it is possible to have three electrical contacts instead of four for electrical contacting of the magnetic field sensor chips in the receiving body.

According to one embodiment, the electrical contacts are designed as lines and/or pins.

According to one embodiment, the sensor comprises a conductor rail or a punched grid or busbar as an electrical signal connection. Alternatively, the sensor can be designed without a conductor rail or punched grid or busbar.

According to one embodiment, the receiving body is configured in such a way that signal cables can be clipped in. Alternatively or additionally, the sensor housing can be configured in such a way that signal cables can be clipped in.

According to one embodiment, the sensor further comprises a temperature measuring cell. For example, the temperature measuring cell can comprise or be an NTC cell, PTC cell or a Z-diode.

According to one embodiment, the sensor is a wheel speed sensor.

According to the invention, a system is further provided which comprises a sensor according to the invention for detecting a rotational speed and/or direction of rotation of a wheel of a vehicle and a pole wheel which can be coupled to the wheel of the vehicle.

All the advantages of a sensor according to the invention can be transferred to the system according to the invention.

According to one embodiment, the pole wheel is a ferritic pole wheel.

According to the invention, there is further provided a vehicle comprising a system according to the invention.

All the advantages of a system according to the invention can be transferred to the vehicle according to the invention.

According to one embodiment, the vehicle is a commercial vehicle such as a truck.

The figures are described below. It is understood that individual features shown in the figures can be combined to form further embodiments. The figures show:

FIG. 1 an embodiment of a sensor according to the invention for detecting a rotational speed and/or direction of rotation of a wheel of a vehicle,

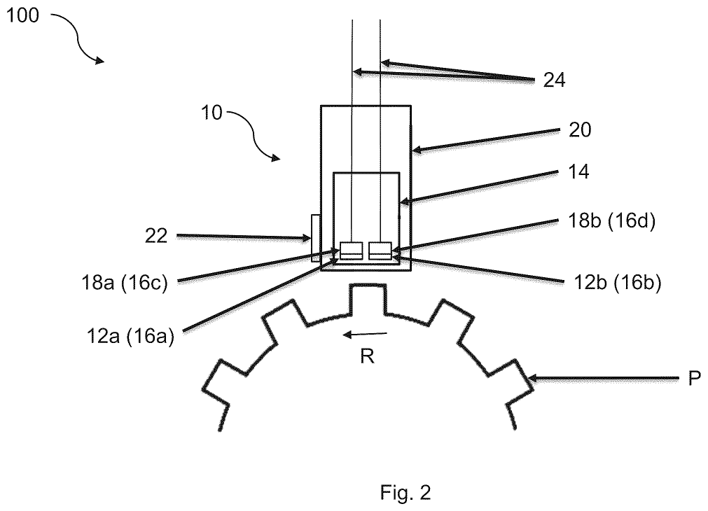

FIG. 2 an embodiment of a system according to the invention,

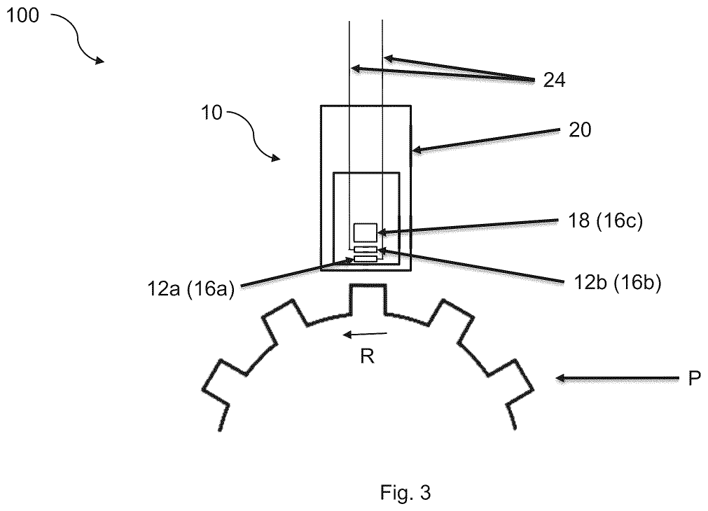

FIG. 3 an embodiment of a system according to the invention, and

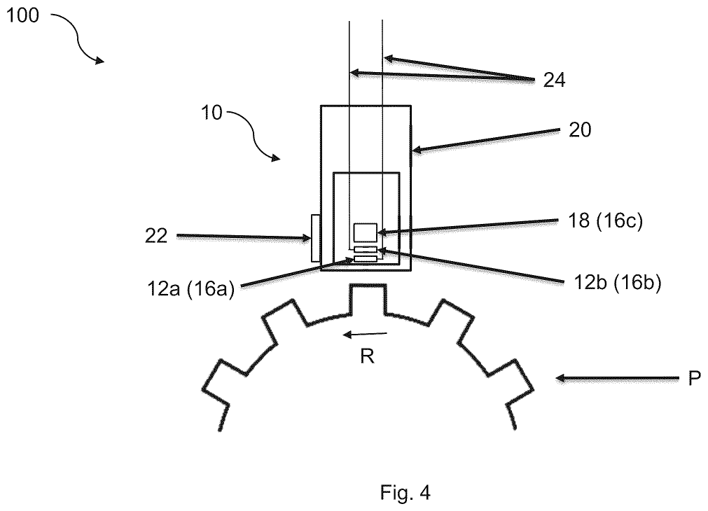

FIG. 4 an embodiment of a system according to the invention.

FIG. 1 shows a perspective view of an embodiment of a sensor according to the invention. In this embodiment, the sensor 10 comprises a cuboidal receiving body 14, which can also assume other geometric shapes.

The receiving body 14 has two opposing receptacles 16a and 16b at one longitudinal end of the receiving body 14, each for a magnetic field sensor chip 12a and 12b. The first receptacle 16a and the second receptacle 16b are arranged next to each other in the receiving body 14. In particular, they can be arranged one above the other. The first and second receptacles 16a, 16b can, for example, each be designed as an insert or as insertion openings. The first receptacle 16a and the second receptacle 16b can, for example, each have two sensor chip contact receptacles 28 in order to receive the contact legs of the first magnetic field sensor chip 12a and of the second magnetic field sensor chip 12b when these are inserted into the respective first receptacle 16a and second receptacle 16b.

The first magnetic field sensor chip 12a and the second magnetic field sensor chip 12b can each have a permanent magnet (not shown), which is integrated in the associated magnetic field sensor chip.

In one embodiment, the sensor 10 further comprises an alignment geometry 26, for example star-shaped, at a longitudinal end of the receiving body 14 opposite the first and second receptacles 16a, 16b, in order to be able to align the receiving body 14 relative to a sensor housing, which is not shown. The alignment geometry 26 can also assume other geometric shapes.

Furthermore, in one embodiment, the sensor 10 comprises a busbar or conductor rail 24 extending from a longitudinal end of the sensor 10 opposite the first and second receptacles 16a, 16b towards the first and second receptacles 16a, 16b, in particular into the sensor chip contact receptacles 28, so that the contact legs of the first magnetic field sensor chip 12a and the second magnetic field sensor chip 12b are in electrical contact with the busbar or conductor rail 24 when they are inserted into the respective first and second receptacles 16a, 16b in the receiving body 14.

The sensor 10 can be signal-connected to an external voltage source (not shown) and/or to other external components such as a signal processing unit (not shown) via the busbar or conductor rail 24 using connection cables 30 or connection wires.

FIG. 2 schematically shows an embodiment of a system 100 according to the invention, which comprises an embodiment of a sensor 10 according to the invention and a pole wheel P, which may in particular be ferritic.

The sensor 10 comprises a receiving body 14 with a first receptacle 16a for a first magnetic field sensor chip 12a and a second receptacle 16b for a second magnetic field sensor chip 12b. The first and second magnetic field sensor chips 12a, 12b are each directional sensor chips. The first magnetic field sensor chip 12a is arranged in the first receptacle 16a and the second magnetic field sensor chip 12b is arranged in the second receptacle 16b. The receiving body 14 can, for example, be cylindrical or cuboid or have another geometric shape. The first and second receptacles 16a, 16b are arranged at an end of the receiving body 14 facing the pole wheel P. The first and second receptacles 16a, 16b are arranged next to each other in parallel in the running direction or direction of rotation R of the pole wheel P.

The sensor 10 further comprises a first permanent magnet 18a and a second permanent magnet 18b. The receiving body 14 can have a third receptacle 16c, in which the first permanent magnet 18a can be accommodated, and a fourth receptacle 16d, in which the second permanent magnet can be accommodated. The third receptacle 16c and thus the first permanent magnet 18a can be arranged in the direction away from the pole wheel P behind the first receptacle 16a, in which the first magnetic field sensor chip 12a is accommodated. The fourth receptacle 16d and thus the second permanent magnet 18b can also be arranged in the direction away from the pole wheel P behind the second receptacle 16b, in which the second magnetic field sensor chip 12b is accommodated. Alternatively, the first permanent magnet can be attached to or integrated in the first magnetic field sensor chip 12a and the second permanent magnet 18b can be attached to or integrated in the second magnetic field sensor chip 12b.

The first permanent magnet 18a is larger than the first magnetic field sensor chip 12a and/or the second magnetic field sensor chip 12b. The second permanent magnet 18b is larger than the second magnetic field sensor chip 12b and/or the first magnetic field sensor chip 12a.

The sensor 10 further comprises two lines as electrical signal connection 24. The first magnetic field sensor chip 12a and the second magnetic field sensor chip 12b are each connected to one of the two lines 24.

Furthermore, the sensor 10 comprises a sensor housing 20 that surrounds the receiving body 14 of the sensor 10. The sensor housing 20 can be cuboidal or cylindrical. It can be adapted to the outer shape of the receiving body 14. The lines of the signal connection 24 protrude from one end of the sensor housing pointing away from the pole wheel P.

The sensor housing 20 has a shape feature 22 on its outer surface in the region of the first and second receptacles 16a, 16b and the first and second magnetic field sensor chips 12a, 12b. This shape feature 22 is an alignment lug or alignment rib extending from the sensor housing 20, in particular in the transverse direction, and in the direction away from the pole wheel P, in order to be able to mount the sensor 10 so that it can be aligned relative to the pole wheel P.

FIG. 3 schematically shows a further embodiment of a system 100 according to the invention. The system 100 comprises an omnidirectional variant of a sensor 10 according to the invention and a pole wheel P, which may in particular be ferritic. In terms of its basic structure, the sensor 10 is similar to the sensor shown in FIG. 1.

The sensor 10 comprises a receiving body 14 with a first receptacle 16a for a first magnetic field sensor chip 12a and a second receptacle 16b for a second magnetic field sensor chip 12b. The first and second magnetic field sensor chips 12a, 12b are each omnidirectional sensor chips. The first magnetic field sensor chip 12a is arranged in the first receptacle 16a and the second magnetic field sensor chip 12b is arranged in the second receptacle 16b. The receiving body 14 can, for example, be cylindrical or cuboidal or have another geometric shape. The first and second receptacles 16a, 16b are arranged at an end of the receiving body 14 facing the pole wheel P. The first and second receptacles 16a, 16b are arranged perpendicular to a running direction or direction of rotation R of the pole wheel P or in a direction away from the pole wheel P next to each other or one behind the other.

The sensor 10 further comprises a permanent magnet 18. The receiving body 14 has a third receptacle 16c in which the permanent magnet 18 is accommodated. The third receptacle 16c and the permanent magnet 18 accommodated therein are arranged in the direction away from the pole wheel P behind the first receptacle 16a, in which the first magnetic field sensor chip 12a is accommodated, and behind the second receptacle 16b, in which the second magnetic field sensor chip 12b is accommodated.

The permanent magnet 18 is larger than the first magnetic field sensor chip 12a and/or the second magnetic field sensor chip 12b.

The sensor 10 further comprises two lines as electrical signal connection 24. The first magnetic field sensor chip 12a and the second magnetic field sensor chip 12b are each connected to one of the two lines 24.

Furthermore, the sensor 10 comprises a sensor housing 20 that surrounds the receiving body 14 of the sensor 10. The sensor housing 20 can be cuboidal or cylindrical. It can be adapted to the outer shape of the receiving body 14. The lines of the signal connection 24 protrude from one end of the sensor housing pointing away from the pole wheel P.

Since these are omnidirectional magnetic field sensor chips 12a, 12b, the sensor housing has no shape feature 22.

FIG. 4 shows a further embodiment of a system 100 according to the invention. The system 100 comprises a directional variant of a sensor 10 according to the invention and a pole wheel P, which may in particular be ferritic. In terms of its basic structure, the sensor 10 is similar to the sensor shown in FIG. 1 and/or FIG. 2.

The sensor 10 comprises a receiving body 14 with a first receptacle 16a for a first magnetic field sensor chip 12a and a second receptacle 16b for a second magnetic field sensor chip 12b. The first and second magnetic field sensor chips 12a, 12b are each directional sensor chips. The first magnetic field sensor chip 12a is arranged in the first receptacle 16a and the second magnetic field sensor chip 12b is arranged in the second receptacle 16b. The receiving body 14 can be cylindrical or cuboidal. The first and second receptacles 16a, 16b are arranged at an end of the receiving body 14 facing the pole wheel P. The first and second receptacles 16a, 16b are arranged perpendicular to a running direction or direction of rotation R of the pole wheel P or in a direction away from the pole wheel P next to each other or one behind the other.

The sensor 10 further comprises a permanent magnet 18. The receiving body 14 has a third receptacle 16c in which the permanent magnet 18 is accommodated. The third receptacle 16c and the permanent magnet 18 accommodated therein are arranged in the direction away from the pole wheel P behind the first receptacle 16a, in which the first magnetic field sensor chip 12a is accommodated, and behind the second receptacle 16b, in which the second magnetic field sensor chip 12b is accommodated.

The sensor 10 further comprises two lines as electrical signal connection 24. The first magnetic field sensor chip 12a and the second magnetic field sensor chip 12b are each connected to one of the two lines 24.

Furthermore, the sensor 10 comprises a sensor housing 20 that surrounds the receiving body 14 of the sensor 10. The sensor housing 20 can be cuboidal or cylindrical. It can be adapted to the outer shape of the receiving body 14. The lines of the signal connection 24 protrude from one end of the sensor housing pointing away from the pole wheel P.

The sensor housing 20 has a shape feature 22 on its outer surface in the region of the first and second receptacles 16a, 16b and the first and second magnetic field sensor chips 12a, 12b. This shape feature 22 is an alignment lug or alignment rib extending from the sensor housing 20 and in the direction away from the pole wheel P, in order to be able to mount the sensor 10 in an alignable manner relative to the pole wheel P.

### LIST OF REFERENCE SIGNS

10 sensor
12a first magnetic field sensor chip
12b second magnetic field sensor chip
14 receiving body
16a first receptacle
16b second receptacle
16c third receptacle
16d fourth receptacle
18 permanent magnet
18a first permanent magnet
18b second permanent magnet
20 sensor housing
22 shape feature
24 electrical signal connection
26 alignment geometry
28 sensor chip contact receptacle
30 connection cable
100 system
P pole wheel
R running direction or direction of rotation of the pole wheel

1. A sensor device for detecting a rotational speed and/or direction of rotation of a wheel of a vehicle, comprising:
a first magnetic field sensor chip;
a second magnetic field sensor chip,
wherein the first and second magnetic field sensor chips are each independently configured to output a sensor signal indicative of a change in a biased magnetic field under an influence of a rotating pole wheel coupled to the wheel of the vehicle;
a receiving body,
wherein the receiving body includes:
a first receptacle through which the first magnetic field sensor chip is received, and
a second receptacle through which the second magnetic field sensor chip is received; and
at least one permanent magnet for generating the biased magnetic field, wherein the at least one permanent magnet is arranged in the receiving body on at least one of the first and second receptacles.

2. The sensor device according to claim 1, wherein the first receptacle and the second receptacle are arranged next to one another transversely to a longitudinal axis of the receiving body, in a tangential direction with respect to the pole wheel.

3. The sensor device according to claim 1, wherein the first and second receptacles are arranged one behind the other along a longitudinal axis of the receiving body, in particular substantially in a radial direction with respect to the pole wheel.

4. The sensor device according to claim 1, wherein the at least one permanent magnet is attached to at least one of the first and second magnetic field sensor chips, wherein the at least one permanent magnet is in particular integrated in at least one of the first and second magnetic field sensor chips.

5. The sensor device according to claim 1, wherein the receiving body comprises a third receptacle (16c) through which the at least one permanent magnet is received.

6. The sensor device according to claim 1, wherein the at least one permanent magnet comprises a first permanent magnet and a second permanent magnet;
wherein the first permanent magnet is arranged on the first receptacle and the second permanent magnet is arranged on the second receptacle.

7. The sensor device according to claim 6, wherein the first permanent magnet is fixed to the first magnetic field sensor chip, wherein the first permanent magnet is in particular integrated in the first magnetic field sensor chip, and the second permanent magnet is fixed to the second magnetic field sensor chip, wherein the second permanent magnet is in particular integrated in the second magnetic field sensor chip.

8. The sensor device according to claim 6, wherein the receiving body comprises a third and a fourth receptacle, wherein the first permanent magnet is received by the third receptacle and the second permanent magnet is received by the fourth receptacle.

9. The sensor device according to claim 1, wherein the first magnetic field sensor chip is a Hall sensor chip or a magnetoresistive sensor chip, and wherein the second magnetic field sensor chip is a Hall sensor chip or a magnetoresistive sensor chip.

10. The sensor device according to claim 1, wherein the first magnetic field sensor chip is a directional sensor chip and the second magnetic field sensor chip is a directional sensor chip; or
wherein the first magnetic field sensor chip is an omnidirectional sensor chip and the second magnetic field sensor chip is an omnidirectional sensor chip.

11. The sensor device according to claim 1, wherein the first and second magnetic field sensor chips are of different chip types.

12. The sensor device according to claim 1, wherein the receptacles, in particular the first and the second receptacle, are formed as chambers in the receiving body.

13. The sensor device according to claim 1, wherein the sensor comprises a sensor housing having a shape feature for aligning the sensor device, in particular an alignment lug.

14. The sensor device according to claim 1, wherein the receiving body comprises three electrical contacts for electrically contacting the first and second magnetic field sensor chips.

15. The sensor device according to claim 1, wherein the sensor device comprises a busbar or a punched grid or busbar as electrical signal connection.

16. The sensor device according to claim 1, further comprising;
a temperature measuring cell.

17. A system comprising:
the sensor device according to claim 1 for detecting a rotational speed and/or direction of rotation of a wheel of a vehicle; and
a pole wheel that can be coupled to the wheel of the vehicle.

18. A vehicle comprising:
the system according to claim 17.
